(19) United States
(12) Patent Application Publication
(10) Pub. No.: US 2025/0253995 A1
(43) Pub. Date: Aug. 7, 2025

(54) SINGLE DCI AND MULTI-PANEL SIMULTANEOUS PUSCH INDICATION

(71) Applicant: APPLE INC., CUPERTINO, CA (US)

(72) Inventors: Seyed Ali Akbar FAKOORIAN, SAN DIEGO, CA (US); Haitong SUN, SARATOGA, CA (US); Yushu ZHANG, BEIJING (CN); Hong HE, CUPERTINO, CA (US); Dawei ZHANG, CUPERTINO, CA (US); Wei ZENG, CUPERTINO, CA (US); Weidong YANG, SAN DIEGO, CA (US)

(21) Appl. No.: 18/857,462

(22) PCT Filed: Apr. 29, 2022
(86) PCT No.: PCT/CN2022/090369

§ 371 Date: Oct. 17, 2024

(51) Int. Cl. H04L 5/00; H04W 72/1263

(52) U.S. Cl. CPC H04L 5/0044; H04W 72/1263; H04L 5/0023

(57) ABSTRACT

Methods and apparatuses for using a single downlink control information (DCI) and supporting simultaneous transmission simultaneous Physical Uplink Shared Channels (PUSCHs) using multiple user equipment (UE) antenna panels are described. In some embodiments, a baseband processor is configured to perform operations comprising: receiving configuration information from a base station, wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel. Once configured, the baseband processor transmits the plurality of PUSCHs simultaneously via the plurality of antenna panels, with one PUSCH of the plurality of PUSCHs being transmitted on a different one of the plurality of PUSCHs.

### FIELD OF INVENTION

This invention relates generally to wireless technology and more particularly to performing resource allocation for a multi-panel simultaneous transmission of multiple Physical Uplink Shared Channels (PUSCHs) using a single downlink control information (DCI).

### BACKGROUND

Fifth generation mobile network (5G) is a wireless standard that aims to improve upon data transmission speed, reliability, availability, and more. This standard, while still developing, includes numerous details relating to various aspects of wireless communication, for example, NR and NR in a spectrum greater than 52.6 GHz.

### SUMMARY OF THE DESCRIPTION

Methods and apparatuses for using a single downlink control information (DCI) and supporting simultaneous transmission simultaneous Physical Uplink Shared Channels (PUSCHs) using multiple user equipment (UE) antenna panels are described.

In some embodiments, a baseband processor is configured to perform operations comprising: receiving configuration information from a base station, wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel, using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources. In some embodiments, the baseband processor also perform operations comprising configuring the UE for transmitting multiple PUSCHs simultaneously using a plurality of antenna panels of the UE based on the configuration information and transmitting the plurality of PUSCHs simultaneously via the plurality of antenna panels, with one PUSCH of the plurality of PUSCHs being transmitted on a different one of the plurality of PUSCHs.

In some other embodiments, a base station comprises a processor (or processing circuitry) configured to perform operations comprising: generating configuration information for configuring a user equipment (UE), wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel, using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources. The base station is also configured to transmit the single DCI to the UE.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry, according to some embodiments.

FIG. 6A illustrates a data flow diagram of some embodiments of single downlink control information (DCI) resource allocation to support multi-panel simultaneous transmission of multiple Physical Uplink Shared Channels (PUSCHs) by a UE.

FIG. 6B illustrates examples of PUSCHs with a full overlap in frequency resources allocated to the PUSCHs that are to be simultaneously transmitted, no overlap in frequency resources allocated to the PUSCHs that are to be simultaneously transmitted and a partial overlap in frequency resources allocated to the PUSCHs that are to be simultaneously transmitted.

FIG. 7 is a flow diagram of some embodiments of a process for configuring a UE.

FIG. 8 is a flow diagram of one embodiment of a process by which network equipment configures a UE.

### DETAILED DESCRIPTION

A method and apparatus of a device that performs resource allocation for a multi-panel simultaneous transmission of multiple Physical Uplink Shared Channels (PUSCHs) using a single downlink control information (DCI) is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that performs resource allocation for a multi-panel simultaneous transmission of multiple Physical Uplink Shared Channels (PUSCHs) using a single downlink control information (DCI) is described. In one embodiment, the device is a user equipment device that has a wireless link with a base station. In one embodiment, the wireless link is a fifth generation (5G) link. The device further groups and selects component carriers (CCs) from the wireless link and determines a virtual CC from a group of selected CCs. The device additionally can perform a physical downlink resource mapping based on an aggregate resource matching patterns of groups of CCs.

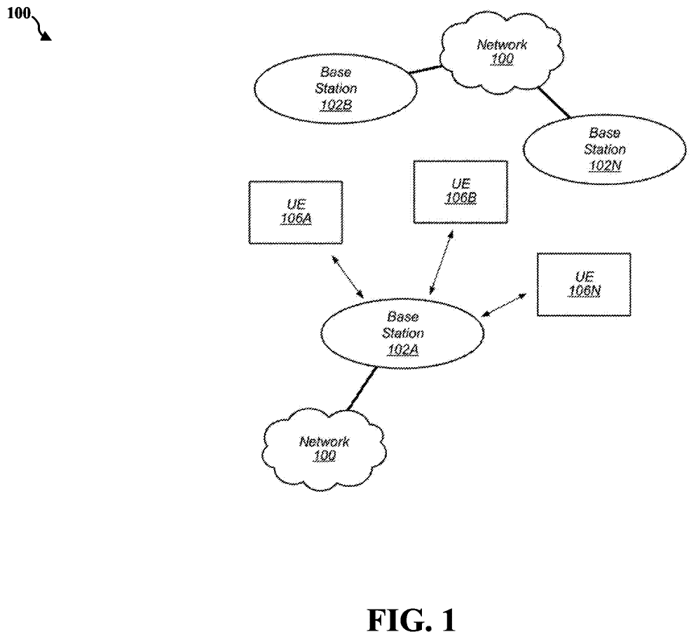

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

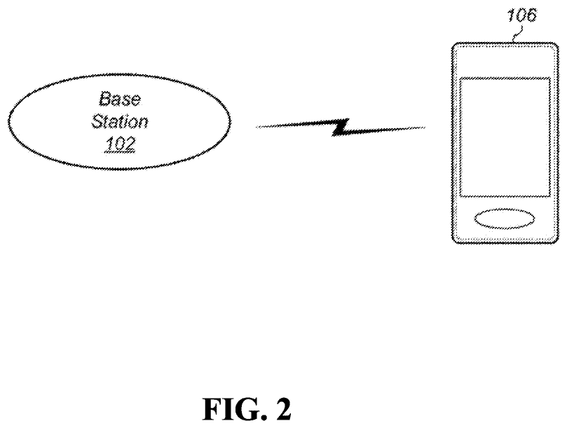

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

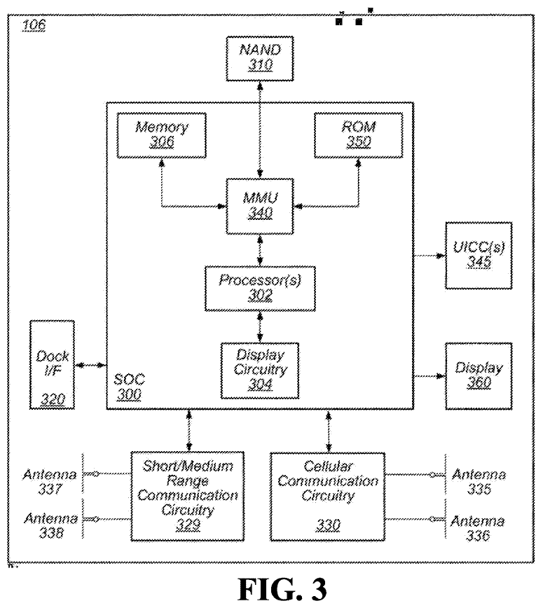

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to receive configuration information from a base station, where the configuration information comprises a single downlink control information (DCI) that specifies an uplink resource allocation for a plurality of Physical Uplink Shared Channels (PUSCHs) and the uplink resource allocation for the plurality of PUSCHs is specified, per user equipment (UE) antenna panel. The wireless device may also be configured transmit information on the plurality of PUSCHs simultaneously via the plurality of antenna panels based on the configuration information in the single DCI, with one PUSCH of the plurality of PUSCHs being transmitted on a different one of the plurality of PUSCHs.

As described herein, the communication device 106 may include hardware and software components for implementing the above features for time division multiplexing UL data for NSA NR operations. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

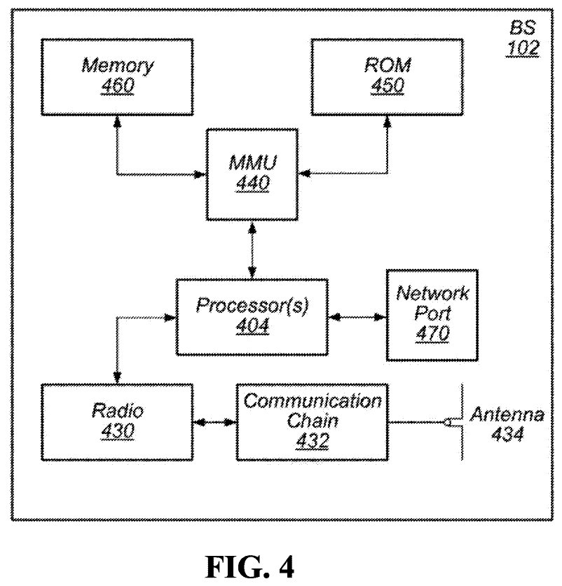

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

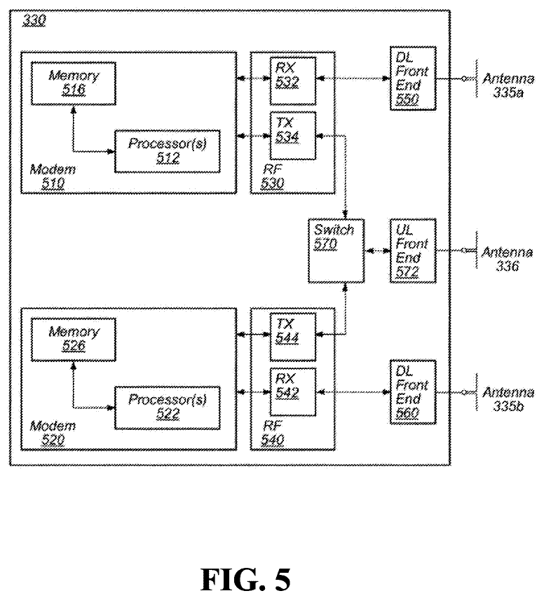

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for performing resource allocation for a multi-panel simultaneous transmission of multiple PUSCHs using a single DCI, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for performing resource allocation for a multi-panel simultaneous transmission of multiple PUSCHs using a single DCI, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

### Single DCI and the Indication of Multi-Panel Simultaneous Transmissions of PUSCHs

In some embodiments, the techniques described herein are for performing resource allocation to signal resources to a UE to enable the UE to simultaneously transmit multiple PUSCHs using multiple antenna panels of the UE. In some embodiments, the resource allocation is performed by a base station (e.g., gNB) using a single DCI.

In NR Release 16, the NR Standard specifies simultaneous Physical Downlink Shared Channel (PDSCH) reception(s) for multi-Transmission and Reception Point (TRP). In this case, if scheduled by a single DCI, PDSCH resources associated to different downlink (DL) beams (spatial Rx filters) are sent via frequency division multiplexing (FDM). As set forth in 3GPP TS 38.214, Sec. 5.1, the UE is indicated with two Transmission Configuration Indication (TCI) states in a codepoint of the DCI field ‘Transmission Configuration Indication’ and demodulation reference signal (DM-RS) port(s) within one code division multiplexing (CDM) group in the DCI field ‘Antenna Port(s)’. When the UE is set to ‘fdmSchemeA’, the UE shall receive a single PDSCH transmission occasion of the Transport Block (TB) with each TCI state associated with a non-overlapping frequency domain resource allocation. When the UE is set to ‘fdmSchemeB’, the UE shall receive two PDSCH transmission occasions of the same TB with each TCI state associated to a PDSCH transmission occasion which has a non-overlapping frequency domain resource allocation. If scheduled using multiple DCIs, referred to as multi-DCI (m-DCI), two PDSCH receptions can be fully/partially/non-overlapped PDSCHs in time and frequency domain. In this case, the PDCCHs that schedule two PDSCHs are associated with different ControlResourceSets having different values of coresetPoolIndex.

In NR Release 17, the UE can transmit multiple repetitions of the same TB across different uplink (UL) beams, where repetitions are transmitted using time division multiplexing (TDM). That is, there is beam hopping but that beam hopping is for TDM. In order to transmit the multiple repetitions of the same TB across different UL beams, the beam indication is provided by extending a Status-Report-Indication (SRI) bit field (done by UE), when the UE is configured for two Sounding Reference signal (SRS) resource sets with usage as codebook (or two SRS resource sets with usage as non-codebook). Also, when transmitting multiple repetitions across different UL beams, all repetitions have the same rank (number of layers), although repetitions over different beams may have different antenna ports, Transmitted Precoding Matrix Indicator (TPMI) (for code block (CB) based transmission), Transmit Power Control (TPC), etc. In other words, the repetition doesn't happen in time; it occurs in different time slots.

In NR Release 16 and Release 17, simultaneous PUSCH transmission is not supported (not for spatial division multiplexing (SDM) nor frequency division multiplexing (FDM).

In NR Release 18, one of the objectives is to study and if needed specify the simultaneous multi-panel UL transmission, including providing an UL precoding indication for PUSCH, considering the use of single DCI and multi-DCI based multi-TRP operation and providing an UL beam indication for PUCCH/PUSCH, considering the use of a single DCI and multi-DCI based multi-TRP operation.

In some embodiments, the UE is configured to perform the transmission of multiple PUSCHs simultaneously using multiple antenna panels on the UE. This is referred to herein as Multi-Panel Simultaneous PUSCHs. In some embodiments, the multiple PUSCH transmissions include two PUSCH transmissions, one PUSCH from one antenna on the UE and another PUSCH from another antenna on the UE, where both UE antennas are part of a multi-panel antenna. The configuration information for configuring the UE to perform the multi-panel simultaneous transmission of multiple PUSCHs is sent from a base station.

In some embodiments, the configuration information is sent from the base station to the UE using a single DCI (s-DCI). In some embodiments, the configuration information comprises resource information corresponding to a resource allocation to indicate to the UE the resources to use for the PUSCH transmissions. The determination of the resource allocation is made by the base station. In some embodiments, the base station determines the resource allocation based on UE capability. The UE capability can be provided by the UE.

In some embodiments, the resource allocation is in frequency and/or space for a number of different cases. For example, in one case, the resource allocation specifies the resources for transmitting a single PUSCH occasion across different panels. In other words, resources are specified for transmitting a single TB (i.e., the same data) across different UE antenna panels simultaneously. Note that in some embodiments, the transmission of the single TB across different UE antenna panels involves transmitting different coded bits from same TB on different panels. In some other embodiments, the transmission of the single TB across different UE antenna panels involves transmitting same data on different panels. For example, the same data could be modulated differently and its transmission repeated such that one goes through layer 1 while another goes through layer 2 with layer 1 being transmitted by a first antenna panel and layer 2 being transmitted by a second antenna panel. Such transmission would improve diversity.

In another case, the resource allocation specifies the resources for performing repetition of the same TB across different panels. In this instance, the data being transmitted by each antenna panel is different. In a third case, the resource allocation specifies the resources for performing simultaneous PUSCH transmissions of two different TBs. In some embodiments, this involves transmitting two different codewords.

Thus, in some embodiments, the resource allocation is indicated to the UE via a single DCI using a combination of higher layer parameters and a dynamic indication the resource allocation for handling one of the cases above. In some embodiments, the based station first determines the transmission scheme (e.g., SDM, FDM, etc.) that the UE is to use for the multiple PUSCH transmissions, and then after determining the transmission scheme (e.g., SDM, FDM, etc.), the base stations determines whether the multiple simultaneous PUSCH transmissions are for transmitting a single TB, multi-TB or repetition. These resources can be determined by the base station based on the UE capability.

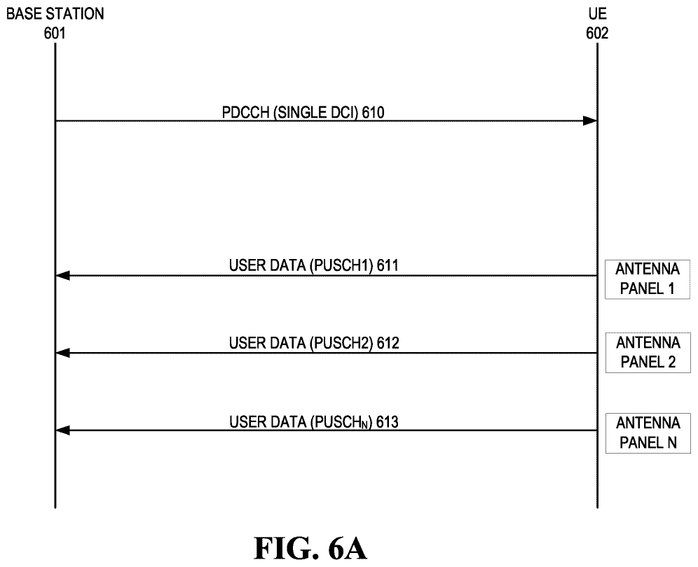

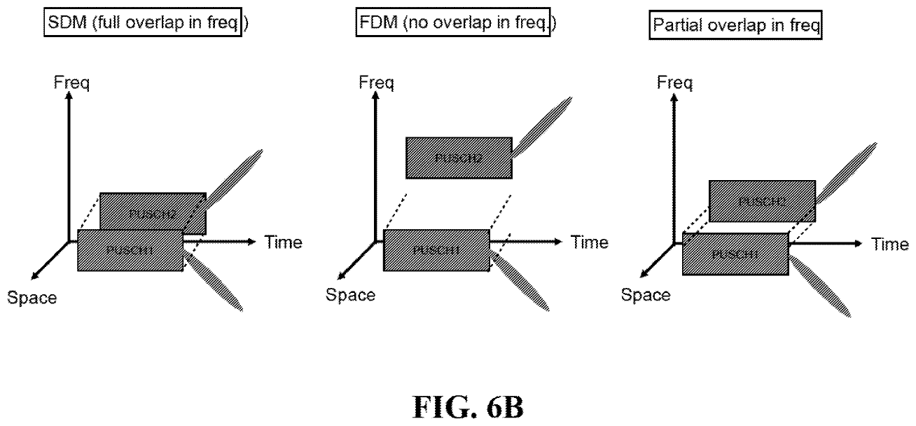

After providing the resource allocation, a determination is made as to the UL beams to be used by the UE for transmissions of the multiple PUSCHs across different panels. FIG. 6A illustrates a data flow diagram of some embodiments of single downlink control information (DCI) resource allocation to support multi-panel simultaneous transmission o of multiple Physical Uplink Shared Channels (PUSCHs) by a UE. Referring to FIG. 6A, base station 601 transmits a single DCI to UE 602. In some embodiments, the single DCI is transmitted as part of PDCCH 610. The single DCI contains an uplink resource allocation for resources to be used by UE 602 to transmit multiple PUSCHs across different panels. In response to the single DCI with the uplink resource allocation, UE 602 transmits user data 611 to base station 601 using its antenna panel 1, user data 612 to base station 601 using its antenna panel 2, . . . , user data 613 to base station 601 using its antenna panel N. In some embodiments, user data 611-613 are transmitted simultaneously by UE 602 using PUSCHs. While FIG. 6A shows N panels being used by UE 602 to transmit up to N PUCSHs transmissions simultaneously, in some embodiments, UE 602 only transmits two PUSCHs simultaneously using two antenna panels. Also, in some other embodiments, the multiple PUCSCHs are transmitted simultaneously to two base stations, with one PUCSH being transmitted to base station 601 and another PUSCH being transmitted to another base station.

In the following description, the following terms may be used:
1. s-DCI: single DCI
2. MPSTx: Multi-Panel Simultaneous Transmission where multiple PUSCHs are transmitted simultaneously over multiple UE antenna panels
3. sdmMPTx: Multi-Panel Simultaneous Transmission where multiple PUSCHs are transmitted simultaneously over multiple UE antenna panels using Spatial Domain Multiplexing
4. fdmMPTx: Multi-Panel Simultaneous Transmission where multiple PUSCHs are transmitted simultaneously over multiple UE antenna panels using Frequency Domain Multiplexing
5. 1sMPTx: one shot (no repetition) transmission of a single transport block (TB) with multi-panel simultaneous transmission in which multiple PUSCHs are transmitted simultaneously over multiple UE antenna panels
6. ReMPTx: repetition (in frequency and/or space) of a single TB with multi-panel simultaneous transmission in which multiple PUSCHs are transmitted simultaneously over multiple UE antenna panels

There are a number of resource allocation schemes that may be used as part of Multi-Panel Simultaneous Transmission for transmitting multiple PUSCHs simultaneously using multiple antenna panels of the UE. Examples of such resource allocation schemes for multi-panel simultaneous transmission are disclosed below. In some embodiments, each of these resource allocation schemes involve allocating resources using a single DCI that specifies an uplink resource allocation for a plurality of Physical Uplink Shared Channels (PUSCHs), wherein the uplink resource allocation for the plurality of PUSCHs is specified, per user equipment (UE) antenna panel.

In some embodiments, the uplink resource allocation for the plurality of PUSCHs is specified using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources.

More specifically, in some embodiments, for s-DCI, based on, or subject, to the UE capability (e.g., the UE indicating its capability with respect to SDM, FDM or a combination of the two), if UE is configured with a sdmMPTx parameter, then multi-panel simultaneous transmission is across SDM resources. In such a case, TDRA and FDRA bit-fields represent resources per panel, where a full resource overlap in time and frequency is assumed for SDM multi-panel simultaneous transmission. FIG. 6B illustrates this case where PUSCH1 represent time and frequency resources associated to panel 1, and PUSCH2 represent time and frequency resources associated to the panel 2, where one occasion is transmitted by panel 1 and one occasion is transmitted by panel 2. Thus, the s-DCI schedules those SDM time and frequency resources for the two panels.

In some embodiments, the uplink resource allocation for the plurality of PUSCHs is specified using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources.

More specifically, in some embodiments, for s-DCI, based on, or subject, to the UE capability (e.g., the UE indicating its capability with respect to SDM, FDM or a combination of the two), if UE is configured with a fdmMPTx parameter, then multi-panel simultaneous transmission is across FDM resources. In such a case, for FDM, the s-DCI includes a resource allocation with the same time domain resources for the two occasions where two PUSCHs are transmitted simultaneously (e.g., multi-panel simultaneous transmission is over the same set of symbols). In some embodiments, a TDRA bit-field in DCI represents the time domain resource allocation for all transmissions.

In some embodiments, for both resource allocation type 0 and type 1 when the multi-panel simultaneous transmission is across FDM resources, a new FDRA field in the s-DCI is added and used for the PUSCH scheduling on the 2nd PUSCH.

In some embodiments, the resource allocation is specified to the UE in the s-DCI differently for resource allocation type 0 and resource allocation type 1. Various embodiments for specifying the resource allocation for resource allocation type 0 and resource allocation type 1 are given below.

To indicate the resource allocation to a UE, for resource allocation type 0, the resource allocation includes a bitmap indication of RBGs. In such a case, there are a number of options that may be used to allocation RBGs. In some embodiments, for resource allocation type 0 in frequency domain, the uplink resource allocation specified in the single DCI for the plurality of PUSCHs, allocates non-consecutive resource block groups (RBGs) to each PUSCH of the plurality of PUSCHs. In some embodiments, the non-consecutive RBGs allocated to each PUSCH comprise even RBGs allocated to a first PUSCH and odd-numbered RBGs allocated to a second PUSCH. In some embodiments, in the case of a resource allocation consisting of only one RBG (special case), a first half of RBs belong to PUSCH1 and 2nd half to PUSCH2, where PUSCH1 represent time and frequency resources associated to panel 1, and PUSCH2 represent time and frequency resources associated to the panel 2.

As another option, in some embodiments, for resource allocation type 0 in the frequency domain, the uplink resource allocation specified in the single DCI for the plurality of PUSCHs, includes a resource block (RB) parameter that indicates a size of consecutive physical resource blocks (PRBs) within the allocated RBs assigned to each PUSCH of the plurality of PUSCHs (e.g., PUSCH1, PUSCH2, etc.). In some embodiments, even-numbered groups of consecutive PRBs within the allocated resource blocks (RBs) are assigned to a first PUSCH and odd-numbered groups of consecutive PRBs within the allocated RBs are assigned to a second PUSCH.

In some embodiments, for resource allocation type 0 in the frequency domain, the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter. In some embodiments, even-numbered bundles of consecutive PRBs are assigned to a first PUSCH and odd-numbered bundles of consecutive PRBs are assigned to a second PUSCH To this end, in some embodiments, a new RRC parameter RBbunle is used in the s-DCI, which is based on which bandwidth part (BWP) is partitioned into consecutive PRBs of size RBbunle. Note that the first and last bundle sizes can be different than RBbunle. In some embodiments, for FIG. 6B, an even RBbunle within the allocated RBs in the s-DCI are associated with PUSCH1 and the odd RBbunle within the allocated RBs in the s-DCI are associated to PUSCH2. In some embodiments, the RBbunle parameter is indicated via Radio Resource Control (RRC) signaling or dynamic signaling.

Note that if the UE indicates that it has capability to both SDM and FDM, in some embodiments, both sdmMPTx and fdmMPTx parameters will be configured, and only one configuration is used.

In some embodiments, the uplink resource allocation in the single DCI for the plurality of PUSCHs for resource allocation type 1 in frequency domain, the s-DCI specifies an allocation of contiguous PRBs for each of the PUSCHs. In some embodiments, for resource allocation type 1, the uplink resource allocation in the single DCI for the plurality of PUSCHs specifies a number of allocated RBs in a FDRA bit-field and a first half of the RBs are assigned to a first PUSCH and a second half of the RBs are assigned to a second PUSCH. In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of a same number of contiguous PRBs for a second PUSCH of the plurality of PUSCHs is indicated by an offset made with respect to an end or start of the resource allocation given by the FDRA bit-field. In some embodiments, the FDRA bit-field indicates N_{PRB} allocated RBs, where ceil (N_{PRB}/2), or alternatively floor (N_{PRB}/2) is assigned to the first PUSCH (FIG. 6B) and the rest of RBs belong to the second PUSCH (FIG. 6B).

In some embodiments, for resource allocation type 1 in frequency domain, the uplink resource allocation in the single DCI for the plurality of PUSCHs indicates the resource allocation of contiguous PRBs for a first PUSCH of the plurality of PUSCHs with a location at which the RBs start and a number of RBs in a FDRA bit-field, and the resource allocation of contiguous PRBs for a second PUSCH of the plurality of PUSCHs is indicated by an offset made with respect to the location at which the RBs allocated for the first PUSCH start modulo a size of a bandwidth part (BWP) containing the contiguous PRBs allocated to the first and second PUSCHs. In some embodiments, the FDRA bit-field indicates the resource allocation associated to the first PUSCH, and the resource allocation for the 2nd PUSCH is determined accordingly, for example, by an offset from the end (or start) of the first resource allocation given by the FDRA bit-field and with either the same number of PRBs (in some embodiments) or to the end (or start) of the BWP (in other embodiments).

In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of contiguous PRBs for a second PUSCH of the plurality of PUSCHs is indicated by an offset made with respect to an end or start of the resource allocation given by the FDRA bit-field to an end or start of a bandwidth part (BWP) containing the contiguous PRBs allocated to the first and second PUSCHs. In some embodiments, the existing procedure for intra-slot frequency hopping is reused to determine the starting RB to each PUSCH (instead of hop), as follows: for the PUSCH1:
RBₛₜₐᵣₜ and L are both given by FDRA bit-field, and

### for the PUSCH2:

RBₛₜₐᵣₜ=(RBₛₜₐᵣₜ+RB_{offset})mod BWP_{size}.

In some embodiments, for resource allocation type 1 in frequency domain, the uplink resource allocation in the single DCI for the plurality of PUSCHs indicates a resource allocation of contiguous PRBs for a first PUSCH of the plurality of PUSCHs includes a resource block (RB) parameter that indicates a size of consecutive physical resource blocks (PRBs) within the allocated RBs assigned to each PUSCH of the plurality of PUSCHs, wherein even-numbered groups of consecutive PRBs within the allocated resource blocks (RBs) are assigned to a first PUSCH and odd-numbered groups of consecutive PRBs within the allocated RBs are assigned to a second PUSCH. This is the same as the second option for Type 0 FDRA.

Alternatively, in the option where the FDRA bit-field indicates the resource allocation associated to the first PUSCH, and the resource allocation for the 2nd PUSCH is determined accordingly, for example, by an offset from the end (or start) of the first resource allocation given by the FDRA bit-field and with either the same number of PRBs (in some embodiments) and or the previous option that reuses the existing procedure for intra-slot frequency hopping, for those RBs that may overlap in frequency across the two PUSCHs, there are a number of alternatives. In some embodiments, a first alternative is that RBs that overlap in frequency across the two PUSCHs are not usable (i.e. dropped) for both PUSCHs. In some other embodiments, a second alternative is that RBs that overlap in frequency across the two PUSCHs are used for transmission by PUSCH1 only. In some other embodiments, a third alternative is that RBs that overlap in frequency across the two PUSCHs is based on whether the UE indicates its capable of partial overlap transmission, and if so, those RBs are used for simultaneous transmission over both PUSCHs (partial/full overlapping in frequency). FIG. 6B also shows the situation where there is a partial overlap in frequency resources allocated to both PUSCH1 and PUSCH2.

In some embodiments, the uplink resource allocation from the base station for allocating resources for the UE to perform transmission of multiple PUSCHs simultaneously using multiple UE antenna panels (e.g., multi-panel) is specified based on UE capability information that the base station has. In some embodiments, the UE capability information is sent, via the UE, and received, by the base station, by Radio Resource Control (RRC) signaling or via dynamic signaling.

In some embodiments, the UE capability information that is used by the base station when allocating uplink resources for the multi-panel, multiple PUSCHs simultaneous transmission specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme. In some embodiments, the UE capability information specifies a combination a two or more of the above information. For example, in some embodiments, the UE capability information specifies a combination a number of code blocks supported when a predetermined number of transmission layers are scheduled. In some other embodiments, the UE capability information specifies a combination a number of code blocks per PUSCH transmission occasion when a predetermined number of transmission layers are scheduled.

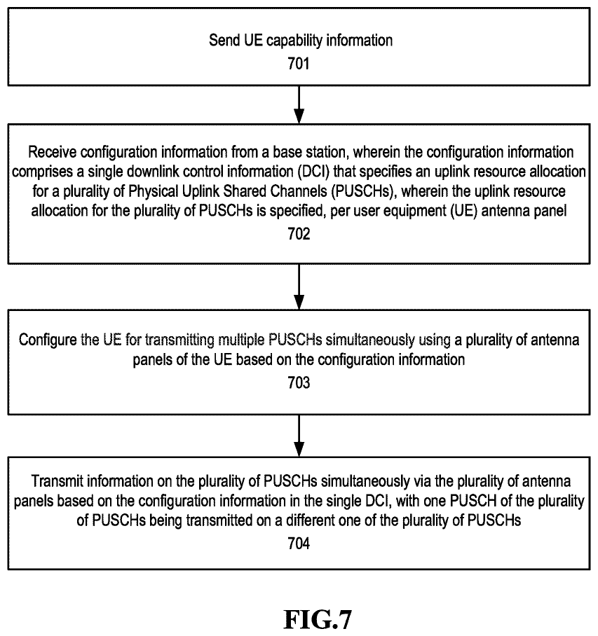

FIG. 7 is a flow diagram of some embodiments of a process for configuring a UE. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system. In some embodiments, the process is performed by a UE in a 5G NR communication system comprising a processor (or processing circuitry) and/or a baseband processor in a 5G NR communication system configured to perform the following operations.

Referring to FIG. 7, the process begins by sending UE capability information (processing block 701). In some embodiments, the UE capability information is sent, via the UE, and received, by the base station, by Radio Resource Control (RRC) signaling or via dynamic signaling. In some embodiments, the UE capability information specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme. In some embodiments, the UE capability information specifies a combination a number of code blocks supported when a predetermined number of transmission layers are scheduled. In some embodiments, the UE capability information specifies a combination a number of code blocks per PUSCH transmission occasion when a predetermined number of transmission layers are scheduled.

Processing logic receives configuration information from a base station, wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel (processing block 702). In some embodiments, the uplink resource allocation is based on UE capability information. In some embodiments, the uplink resource allocation for the plurality of PUSCHs is specified using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources.

In some embodiments, for resource allocation type 0 in frequency domain, the uplink resource allocation specified in the single DCI for the plurality of PUSCHs, allocates resource block groups (RBGs) to each PUSCH of the plurality of PUSCHs. In some embodiments, the RBGs allocated to each PUSCH comprise even-numbered RBGs allocated to a first PUSCH and odd-numbered RBGs allocated to a second PUSCH.

In some embodiments, for resource allocation type 0 in frequency domain, the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter. In some embodiments, even-numbered bundles of consecutive PRBs are assigned to a first PUSCH and odd-numbered bundles of consecutive PRBs are assigned to a second PUSCH. In some embodiments, even-numbered bundles of consecutive PRBs within the allocated resource blocks (RBs) are assigned to a first PUSCH and odd-numbered bundles of consecutive PRBs within the allocated RBs are assigned to a second PUSCH.

In some embodiments, for resource allocation type 1 in frequency domain, the uplink resource allocation in the single DCI for the plurality of PUSCHs specifies a number of allocated RBs in a FDRA bit-field and a first portion of the RBs are assigned to a first PUSCH and a second portion of the RBs representing a remainder of the RBs are assigned to a second PUSCH. In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of a same number of contiguous PRBs for a second PUSCH of the plurality of PUSCHs is indicated by an offset made with respect to an end or start of the resource allocation given by the FDRA bit-field. In some embodiments, for resource allocation type 1 in frequency domain, the uplink resource allocation in the single DCI for the plurality of PUSCHs indicates the resource allocation of contiguous PRBs for a first PUSCH of the plurality of PUSCHs with a location at which the RBs start and a number of RBs in a FDRA bit-field, and the resource allocation of contiguous PRBs for a second PUSCH of the plurality of PUSCHs is indicated by an offset made with respect to the location at which the RBs allocated for the first PUSCH start modulo a size of a bandwidth part (BWP) containing the contiguous PRBs allocated to the first and second PUSCHs.

In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of contiguous PRBs for a second PUSCH of the plurality of PUSCHs is indicated by an offset made with respect to an end or start of the resource allocation given by the FDRA bit-field to an end or start of a bandwidth part (BWP) containing the contiguous PRBs allocated to the first and second PUSCHs. In some embodiments, for resource allocation type 1 in frequency domain, the uplink resource allocation in the single DCI for the plurality of PUSCHs indicates one or more bundles of physical resource blocks (PRBs) for each PUSCH in the plurality of PUSCHs, wherein bundle size of physical resource blocks (PRBs) is set by PRB bundle parameter. In some embodiments, even-numbered bundles of consecutive PRBs are assigned to a first PUSCH and odd-numbered bundles of consecutive PRBs are assigned to a second PUSCH, wherein even-numbered bundles of consecutive PRBs within the allocated resource blocks (RBs) are assigned to a first PUSCH and odd-numbered bundles of consecutive PRBs within the allocated RBs are assigned to a second PUSCH.

In response to the configuration information, processing logic configures the UE for transmitting multiple PUSCHs simultaneously using a plurality of antenna panels of the UE based on the configuration information (processing block 703), and subsequently thereafter, processing logic transmits information on the plurality of PUSCHs simultaneously via the plurality of antenna panels based on the configuration information in the single DCI, with one PUSCH of the plurality of PUSCHs being transmitted on a different one of the plurality of PUSCHs (processing block 704).

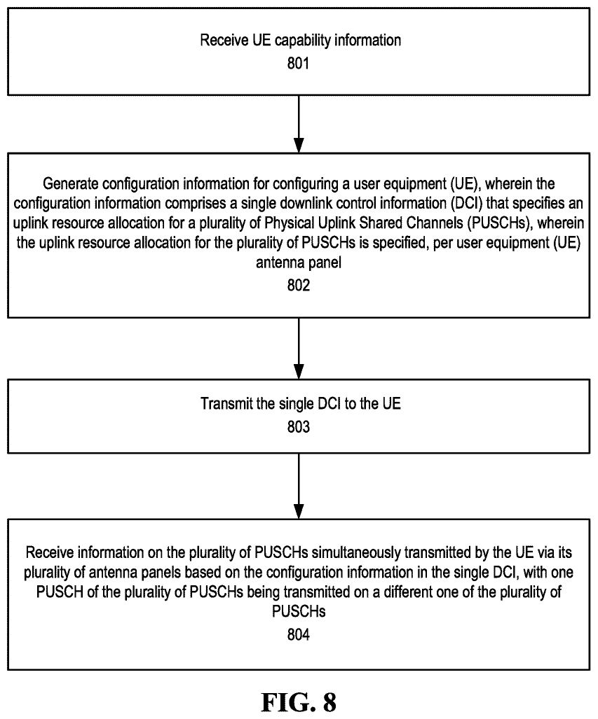

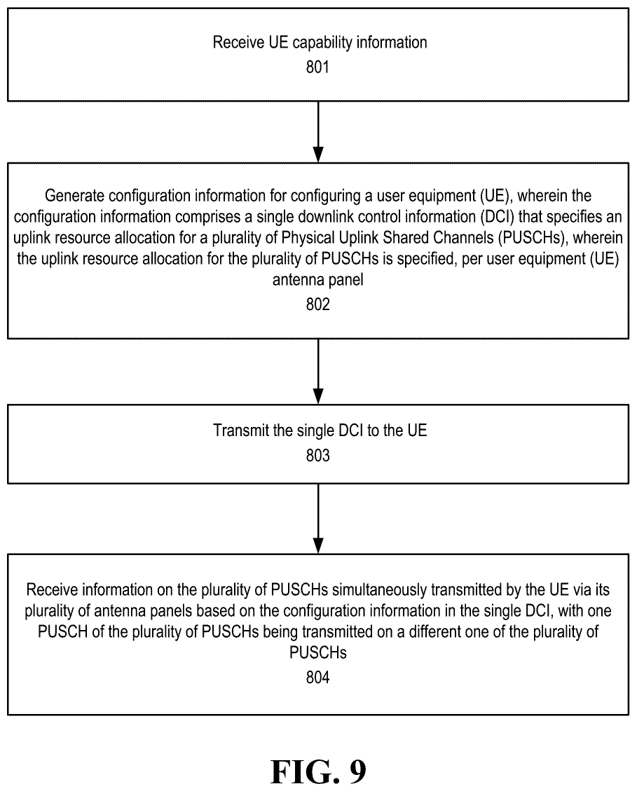

FIG. 8 is a flow diagram of one embodiment of a process by which network equipment configures a UE. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by network equipment operating in a 5G new radio a spectrum in 5G new radio (NR) above 52.6 GHz. In some embodiments, the process is performed by a base station comprising a processor (or processing circuitry) configured to perform the following operations.

Referring to FIG. 8, the process begins by receiving UE capability information (processing block 801). In some embodiments, the UE capability information is sent, via the UE, and received, by the base station, by Radio Resource Control (RRC) signaling or via dynamic signaling.

In some embodiments, the UE capability information specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme. In some embodiments, the UE capability information specifies a combination a number of code blocks supported when a predetermined number of transmission layers are scheduled. In some embodiments, the UE capability information specifies a combination a number of code blocks per PUSCH transmission occasion when a predetermined number of transmission layers are scheduled.

Processing logic generates configuration information for configuring a user equipment (UE), wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel (processing block 802). In some embodiments, the uplink resource allocation is based on UE capability information. In some embodiments, the uplink resource allocation for the plurality of PUSCHs is specified using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources.

In some embodiments, for resource allocation type 0 in frequency domain, the uplink resource allocation specified in the single DCI for the plurality of PUSCHs, allocates resource block groups (RBGs) to each PUSCH of the plurality of PUSCHs. In some embodiments, the RBGs allocated to each PUSCH comprise even RBGs allocated to a first PUSCH and odd-numbered RBGs allocated to a second PUSCH.

In some embodiments, for resource allocation type 0 in frequency domain, the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter. In some embodiments, even-numbered bundles of consecutive PRBs are assigned to a first PUSCH and odd-numbered bundles of consecutive PRBs are assigned to a second PUSCH. In some embodiments, even-numbered bundles of consecutive PRBs within the allocated resource blocks (RBs) are assigned to a first PUSCH and odd-numbered bundles of consecutive PRBs within the allocated RBs are assigned to a second PUSCH.

In some embodiments, for resource allocation type 1 in frequency domain, the uplink resource allocation in the single DCI for the plurality of PUSCHs specifies a number of allocated RBs in a FDRA bit-field and a first portion of the RBs are assigned to a first PUSCH and a second portion of the RBs representing a remainder of the RBs are assigned to a second PUSCH. In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of a same number of contiguous PRBs for a second PUSCH of the plurality of PUSCHs is indicated by an offset made with respect to an end or start of the resource allocation given by the FDRA bit-field. In some embodiments, for resource allocation type 1 in frequency domain, the uplink resource allocation in the single DCI for the plurality of PUSCHs indicates the resource allocation of contiguous PRBs for a first PUSCH of the plurality of PUSCHs with a location at which the RBs start and a number of RBs in a FDRA bit-field, and the resource allocation of contiguous PRBs for a second PUSCH of the plurality of PUSCHs is indicated by an offset made with respect to the location at which the RBs allocated for the first PUSCH start modulo a size of a bandwidth part (BWP) containing the contiguous PRBs allocated to the first and second PUSCHs.

In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of contiguous PRBs for a second PUSCH of the plurality of PUSCHs is indicated by an offset made with respect to an end or start of the resource allocation given by the FDRA bit-field to an end or start of a bandwidth part (BWP) containing the contiguous PRBs allocated to the first and second PUSCHs. In some embodiments, for resource allocation type 1 in frequency domain, the uplink resource allocation in the single DCI for the plurality of PUSCHs indicates one or more bundles of physical resource blocks (PRBs) for each PUSCH in the plurality of PUSCHs, wherein bundle size of physical resource blocks (PRBs) is set by PRB bundle parameter. In some embodiments, even-numbered bundles of consecutive PRBs are assigned to a first PUSCH and odd-numbered bundles of consecutive PRBs are assigned to a second PUSCH, wherein even-numbered bundles of consecutive PRBs within the allocated resource blocks (RBs) are assigned to a first PUSCH and odd-numbered bundles of consecutive PRBs within the allocated RBs are assigned to a second PUSCH.

After creating the configuration information for the single DCI, processing logic transmits the single DCI to the UE (processing block 803). In some embodiments, processing logic transmits the single DCI to the UE using the PDDCH.

Subsequently, processing logic receives information on the plurality of PUSCHs simultaneously transmitted by the UE via its plurality of antenna panels based on the configuration information in the single DCI, with one PUSCH of the plurality of PUSCHs being transmitted on a different one of the plurality of PUSCHs (processing block 804).

There are a number of example embodiments described herein.
Example 1 is a method that may be performed by a baseband processor or UE, where the method includes receiving configuration information from a base station, wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel, using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources; configuring the UE for transmitting multiple PUSCHs simultaneously using a plurality of antenna panels of the UE based on the configuration information; and transmitting information on the plurality of PUSCHs simultaneously via the plurality of antenna panels based on the configuration information in the single DCI, with one PUSCH of the plurality of PUSCHs being transmitted on a different one of the plurality of PUSCHs.
Example 2 is the method of example 1 that may optionally include that, for resource allocation type 0 in frequency domain, the uplink resource allocation specified in the single DCI for the plurality of PUSCHs, allocates resource block groups (RBGs) to each PUSCH of the plurality of PUSCHs.
Example 3 is the method of example 1 that may optionally include that the RBGs allocated to each PUSCH comprise even RBGs allocated to a first PUSCH and odd-numbered RBGs allocated to a second PUSCH.
Example 4 is the method of example 1 that may optionally include that the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH.
Example 5 is the method of example 1 that may optionally include that the PRB bundle parameter is indicated via Radio Resource Control (RRC) signaling.
Example 6 is the method of example 1 that may optionally include that, for resource allocation type 1 in frequency domain, the uplink resource allocation in the single DCI for the plurality of PUSCHs specifies a number of allocated RBs in a FDRA bit-field and a first portion of the RBs are assigned to a first PUSCH and a second portion of the RBs representing a remainder of the RBs are assigned to a second PUSCH.
Example 7 is the method of example 1 that may optionally include that, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of a same number of contiguous PRBs for a second PUSCH of the plurality of PUSCHs is indicated by an offset made with respect to an end or start of the resource allocation given by the FDRA bit-field.
Example 8 is the method of example 1 that may optionally include that, for resource allocation type 1 in frequency domain, the uplink resource allocation in the single DCI for the plurality of PUSCHs indicates the resource allocation of contiguous PRBs for a first PUSCH of the plurality of PUSCHs with a location at which the RBs start and a number of RBs in a FDRA bit-field, and the resource allocation of contiguous PRBs for a second PUSCH of the plurality of PUSCHs is indicated by an offset made with respect to the location at which the RBs allocated for the first PUSCH start modulo a size of a bandwidth part (BWP) containing the contiguous PRBs allocated to the first and second PUSCHs.
Example 9 is the method of example 1 that may optionally include that, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of contiguous PRBs for a second PUSCH of the plurality of PUSCHs is indicated by an offset made with respect to an end or start of the resource allocation given by the FDRA bit-field to an end or start of a bandwidth part (BWP) containing the contiguous PRBs allocated to the first and second PUSCHs.
Example 10 is the method of example 1 that may optionally include that the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH.
Example 11 is the method of example 1 that may optionally include that the uplink resource allocation is based on UE capability information.
Example 12 is the method of example 11 that may optionally include signaling UE capability via Radio Resource Control (RRC) signaling or via dynamic signaling.
Example 13 is the method of example 11 that may optionally include that the UE capability information specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme.
Example 14 is the method of example 13 that may optionally include that the UE capability information specifies a combination a number of code blocks supported when a predetermined number of transmission layers are scheduled.
Example 15 is the method of example 13 that may optionally include that the UE capability information specifies a combination a number of code blocks per PUSCH transmission occasion when a predetermined number of transmission layers are scheduled.
Example 16 is a baseband processor configured to perform any one of the operations set forth in examples 1-15.
Example 17 is a UE configured to perform any one of the operations set forth in examples 1-15.
Example 18 is one or more non-transitory computer readable storage media having instructions stored thereupon which, when executed by a UE or baseband processor causes any one of the operations set forth in examples 1-15 to be performed.
Example 19 is a method performed by a base station having a processor (or processing circuitry) configured to perform operations comprising: generating configuration information for configuring a user equipment (UE), wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel, using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources; and transmitting the single DCI to the UE.
Example 20 is the method of example 19 that may optionally include that, for resource allocation type 0 in frequency domain, the uplink resource allocation specified in the single DCI for the plurality of PUSCHs, allocates resource block groups (RBGs) to each PUSCH of the plurality of PUSCHs.
Example 21 is the method of example 19 that may optionally include that the RBGs allocated to each PUSCH comprise even RBGs allocated to a first PUSCH and odd-numbered RBGs allocated to a second PUSCH.
Example 22 is the method of example 19 that may optionally include that the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH.
Example 23 is the method of example 19 that may optionally include that the PRB bundle parameter is indicated via Radio Resource Control (RRC) signaling.
Example 24 is the method of example 19 that may optionally include that, for resource allocation type 1 in frequency domain, the uplink resource allocation in the single DCI for the plurality of PUSCHs specifies a number of allocated RBs in a FDRA bit-field and a first portion of the RBs are assigned to a first PUSCH and a second portion of the RBs representing a remainder of the RBs are assigned to a second PUSCH.
Example 25 is the method of example 19 that may optionally include that, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of a same number of contiguous PRBs for a second PUSCH of the plurality of PUSCHs is indicated by an offset made with respect to an end or start of the resource allocation given by the FDRA bit-field.
Example 26 is the method of example 19 that may optionally include that, for resource allocation type 1 in frequency domain, the uplink resource allocation in the single DCI for the plurality of PUSCHs indicates the resource allocation of contiguous PRBs for a first PUSCH of the plurality of PUSCHs with a location at which the RBs start and a number of RBs in a FDRA bit-field, and the resource allocation of contiguous PRBs for a second PUSCH of the plurality of PUSCHs is indicated by an offset made with respect to the location at which the RBs allocated for the first PUSCH start modulo a size of a bandwidth part (BWP) containing the contiguous PRBs allocated to the first and second PUSCHs.
Example 27 is the method of example 19 that may optionally include that, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of contiguous PRBs for a second PUSCH of the plurality of PUSCHs is indicated by an offset made with respect to an end or start of the resource allocation given by the FDRA bit-field to an end or start of a bandwidth part (BWP) containing the contiguous PRBs allocated to the first and second PUSCHs.
Example 28 is the method of example 19 that may optionally include that the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH.
Example 29 is the method of example 19 that may optionally include that the uplink resource allocation is based on UE capability information.
Example 30 is the method of example 29 that may optionally include signaling UE capability via Radio Resource Control (RRC) signaling or via dynamic signaling.
Example 31 is the method of example 29 that may optionally include that the UE capability information specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, or a transmission scheme.
Example 32 is the method of example 31 that may optionally include that the UE capability information specifies a combination a number of code blocks supported when a predetermined number of transmission layers are scheduled.
Example 33 is the method of example 31 that may optionally include that the UE capability information specifies a combination a number of code blocks per PUSCH transmission occasion when a predetermined number of transmission layers are scheduled.
Example 34 is a baseband processor of a base station configured to perform any one of the operations set forth in examples 19-33.
Example 35 is a base station configured to perform any one of the operations set forth in examples 19-33.
Example 38 is one or more non-transitory computer readable storage media of a base station having instructions stored thereupon which, when executed by a UE or baseband processor causes any one of the operations set forth in examples 19-33 to be performed.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A baseband processor configured to perform operations comprising:
receiving configuration information from a base station, wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel,
using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or
using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources;
configuring the UE for transmitting multiple PUSCHs simultaneously using a plurality of antenna panels of the UE based on the configuration information; and
transmitting information on the plurality of PUSCHs simultaneously via the plurality of antenna panels based on the configuration information in the single DCI, with one PUSCH of the plurality of PUSCHs being transmitted on a different one of the plurality of PUSCHs.

2. The baseband processor of claim 1 wherein, for resource allocation type 0 in frequency domain, the uplink resource allocation specified in the single DCI for the plurality of PUSCHs, allocates resource block groups (RBGs) to each PUSCH of the plurality of PUSCHs.

3. The baseband processor of claim 1 wherein the RBGs allocated to each PUSCH comprise even RBGs allocated to a first PUSCH and odd-numbered RBGs allocated to a second PUSCH.

4. The baseband processor of claim 1 wherein the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH, and further wherein the PRB bundle parameter is indicated via Radio Resource Control (RRC) signaling.

5. The baseband processor of claim 1 wherein, for resource allocation type 1 in frequency domain, the uplink resource allocation in the single DCI for the plurality of PUSCHs specifies a number of allocated RBs in a FDRA bit-field and a first portion of the RBs are assigned to a first PUSCH and a second portion of the RBs representing a remainder of the RBs are assigned to a second PUSCH.

6. The baseband processor of claim 1 wherein, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of a same number of contiguous PRBs for a second PUSCH of the plurality of PUSCHs is indicated by an offset made with respect to an end or start of the resource allocation given by the FDRA bit-field.

7. The baseband processor of claim 1 wherein, for resource allocation type 1 in frequency domain, the uplink resource allocation in the single DCI for the plurality of PUSCHs indicates the resource allocation of contiguous PRBs for a first PUSCH of the plurality of PUSCHs with a location at which the RBs start and a number of RBs in a FDRA bit-field, and the resource allocation of contiguous PRBs for a second PUSCH of the plurality of PUSCHs is indicated by an offset made with respect to the location at which the RBs allocated for the first PUSCH start modulo a size of a bandwidth part (BWP) containing the contiguous PRBs allocated to the first and second PUSCHs.

8. The baseband processor of claim 1 wherein, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of contiguous PRBs for a second PUSCH of the plurality of PUSCHs is indicated by an offset made with respect to an end or start of the resource allocation given by the FDRA bit-field to an end or start of a bandwidth part (BWP) containing the contiguous PRBs allocated to the first and second PUSCHs.

9. The baseband processor of claim 1 wherein the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH.

10. The baseband processor of claim 1 wherein the uplink resource allocation is based on UE capability information, and wherein the operations further comprise signaling UE capability via Radio Resource Control (RRC) signaling or via dynamic signaling.

11. The baseband processor of claim 11 wherein the UE capability information specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme.

12. The baseband processor of claim 13 wherein the UE capability information specifies a combination a number of code blocks supported when a predetermined number of transmission layers are scheduled.

13. The baseband processor of claim 13 wherein the UE capability information specifies a combination a number of code blocks per PUSCH transmission occasion when a predetermined number of transmission layers are scheduled.

14. A method performed by a user equipment (UE), the method comprising:
receiving configuration information from a base station, wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel,
using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or
using one time domain resource allocation (TDRA) bit-field in the single DCI to represent a time domain resource allocation when the UE is configured to perform simultaneous multi-panel transmission across frequency domain multiplexing (FDM) resources or across both FDM resources and SDM resources;
configuring the UE for transmitting multiple PUSCHs simultaneously using a plurality of antenna panels of the UE based on the configuration information; and
transmitting information on the plurality of PUSCHs simultaneously via the plurality of antenna panels based on the configuration information in the single DCI, with one PUSCH of the plurality of PUSCHs being transmitted on a different one of the plurality of PUSCHs.

15. The method of claim 14 wherein, for resource allocation type 0 in frequency domain, the uplink resource allocation specified in the single DCI for the plurality of PUSCHs, allocates resource block groups (RBGs) to each PUSCH of the plurality of PUSCHs.

16. The baseband processor of claim 1 wherein the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH, and further wherein the PRB bundle parameter is indicated via Radio Resource Control (RRC) signaling.

17. The method of claim 14 wherein, for resource allocation type 1 in frequency domain, the uplink resource allocation in the single DCI for the plurality of PUSCHs specifies a number of allocated RBs in a FDRA bit-field and a first portion of the RBs are assigned to a first PUSCH and a second portion of the RBs representing a remainder of the RBs are assigned to a second PUSCH.

18. A base station comprising a processor (or processing circuitry) configured to perform operations comprising:
generating configuration information for configuring a user equipment (UE), wherein the configuration information comprises a single downlink control information (DCI) that specifies an uplink resource allocation for a plurality of Physical Uplink Shared Channels (PUSCHs), wherein the uplink resource allocation for the plurality of PUSCHs is specified, per user equipment (UE) antenna panel,
using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources, or
using one time domain resource allocation (TDRA) bit-field in the single DCI to represent a time domain resource allocation when the UE is configured to perform simultaneous multi-panel transmission across frequency domain multiplexing (FDM) resources or across both FDM resoures and SDM resources; and
transmitting the single DCI to the UE.

19. The base station of claim 18 wherein, for resource allocation type 0 in frequency domain, the uplink resource allocation specified in the single DCI for the plurality of PUSCHs, allocates resource block groups (RBGs) to each PUSCH of the plurality of PUSCHs.

20. The base station of claim 18 wherein the uplink resource allocation specified in the single DCI for the plurality of PUSCHs, includes one or more bundles of physical resource blocks (PRBs) for each PUSCH in the plurality of PUSCHs, wherein bundle size of physical resource blocks (PRBs) is set by PRB bundle parameter, wherein even-numbered bundles of consecutive PRBs are assigned to a first PUSCH and odd-numbered bundles of consecutive PRBs are assigned to a second PUSCH.
